(19) United States
(12) Patent Application Publication
(10) Pub. No.: US 2023/0142112 A1
(43) Pub. Date: May 11, 2023

(54) Coating

(71) Applicant: Nippon Telegraph and Telephone Corporation, Tokyo (JP)

(72) Inventors: Takashi Miwa, Tokyo (JP); Azusa Ishii, Tokyo (JP); Masamitsu Watanabe, Tokyo (JP); Soichi Oka, Tokyo (JP)

(21) Appl. No.: 17/913,344

(22) PCT Filed: Apr. 6, 2020
(86) PCT No.: PCT/JP2020/015499

§ 371 Date: Sep. 21, 2022

(51) Int. Cl. C09D 7/61; C09D 7/65; C09D 163/00

(52) U.S. Cl. CPC C09D 7/61; C09D 7/65; C09D 163/00

(57) ABSTRACT

A paint comprises a zinc powder, a binder made of an organic resin, calcium sulfate, and a dispersant, wherein a content of the calcium sulfate is 0.046 to 0.186 mol per 100 g of a heating residue of a coating film (from which sulfate added is excluded), a weight ratio of zinc to a dried coating film from which the calcium sulfate is excluded is 70 wt %, a weight ratio of the dispersant to the calcium sulfate is 0.05 to 0.5 wt %, and the dispersant is constituted by at least one of a block copolymer having a basic group with pigment affinity, an oil-soluble non-ionic active agent, and a polyether-modified silicone.

### CROSS-REFERENCE TO RELATED APPLICATIONS

This application is a national phase entry of PCT Application No. PCT/JP2020/015499, filed on Apr. 6, 2020, which application is hereby incorporated herein by reference.

### TECHNICAL FIELD

The present invention relates to a paint that is used for protecting the surface of a metal such as a steel product.

### BACKGROUND

One of the anti-corrosion paints which protect metal materials (mainly, steel) from corrosion is zinc-rich paints. The zinc-rich paints are paints supplemented with a high concentration (70 wt % or more after drying of a coating film) of a powder of zinc, and are widely used. Owing to the zinc powder contained at a high concentration, the zinc-rich paints exert a sacrificial protective effect on a more noble metal than zinc even when a coating film is scratched to expose a metal of a base material. Furthermore, zinc ions eluted from the zinc powder in the zinc-rich paints form a corrosion product of zinc at the exposed portion so that the corrosion product serves as a protective covering. Thus, the zinc-rich paints can form a coating film that exhibits an excellent corrosion protective effect based on a sacrificial protective effect or a protective covering effect brought about by zinc.

### CITATION LIST

### Patent Literature

Patent Literature 1: International Publication No. WO 2020/008753

Non-Patent Literature

Non-Patent Literature 1: Japan Mining Industry Association, Lead Zinc Development Center, “Zinc Handbook, revised edition”, p. 360, 1993

Non-Patent Literature 2: Japan Paint Manufacturers Association, Technical Committee, Heavy-Duty Anti-corrosion Paint Group, “Heavy-Duty Anti-corrosion Paint Guidebook, the fourth edition”, p. 28, 2013.

### SUMMARY

### Technical Problem

As mentioned above, although zinc-rich paints deliver excellent performance such as a sacrificial protective effect and a protective covering effect, neither the sacrificial protective effect nor the protective covering effect works any longer after corrosion and consumption of zinc in a formed coating film.

Zinc-rich paints further coated with another paint such as an undercoat or middle coat paint of an epoxy resin paint or a polyurethane resin or fluorine resin topcoat present no problem. However, the studies of the inventors have revealed that when a zinc-rich paint is used alone to expose a coating film of the zinc-rich paint to the atmosphere, the corrosion of the zinc powder in the coating film proceeds and this portion serves as a path for corrosion factors such as water, oxygen, and salts, thereby reducing barrier properties against the corrosion factors while reducing corrosion protective properties.

It has heretofore been considered that when a zinc powder in a coating film corrodes, voids in the coating film are filled with a corrosion product of zinc to enhance barrier properties against corrosion factors such as water, oxygen, and salts (see Non-Patent Literatures 1 and 2). However, this conventional finding is presumably an event limited to inorganic zinc-rich paints with voids in an initial coating film. For organic zinc-rich paints, an initial coating film has no void. The studies of the inventors have confirmed that when zinc in the coating film is converted to a corrosion product by corrosion, this portion serves as a path for corrosion factors such as water, oxygen, and salts, thereby reducing barrier properties against the corrosion factors. When a coating film of a zinc-rich paint is exposed to the atmosphere, the corrosion of zinc in the coating film proceeds from the coating film surface toward the inside of the coating film so that the film thickness of a sound portion where zinc does not corrode is decreased.

Possible measures against the consumption of zinc in a coating film by corrosion are decrease in the corrosion rate of zinc. If the corrosion rate of zinc can be decreased, a sacrificial protective effect and a protective covering effect brought about by zinc last for a long period at a scratched portion in a coating film.

If the corrosion rate of zinc can be decreased, the corrosion of zinc from the coating film surface exposed to the atmosphere toward the inside of the coating film proceeds slowly. Therefore, the rate at which the film thickness of a sound portion in the coating film is decreased by the corrosion of zinc in the coating film can also be decreased at an unscratched portion in the coating film.

In order to decrease the corrosion rate of zinc, for example, zinc-rich paints supplemented with aluminum, aluminum-magnesium alloy, or the like are commercially available. Also, there is zinc-based alloy plating having a lower corrosion rate than that of galvanization. Likewise, powders for use in zinc-rich paints may be changed to powders of zinc-based alloy having a lower corrosion rate than that of zinc. However, these techniques lead to elevation in cost and present problems such as difficult processing (production) into particle shapes or particle sizes suitable for zinc-rich paints.

In order to decrease the corrosion rate of zinc, a technique of intentionally depositing a large amount of a corrosion product of zinc having high corrosion protective properties by adding calcium sulfate (dihydrate) to a zinc-rich paint has also been proposed (see Patent Literature 1). However, when calcium sulfate is added in a large amount, the calcium sulfate powder aggregates, which cannot thus be uniformly dispersed in a coating film. For example, Patent Literature 1 states that when the weight ratio of calcium sulfate to a heating residue of a zinc-rich paint is 100:16 or more, corrosion protective properties are reduced as compared with the case where the weight ratio is 100:8. When the weight ratio mentioned above is 100:8, the resulting paint, albeit having good corrosion protective properties, is difficult to apply and has poor workability.

Embodiments of the present invention have been made to solve the problems as described above. An object of embodiments of the present invention is to achieve a paint that permits uniform dispersion of calcium sulfate though including a large amount of calcium sulfate, has favorable corrosion protective properties, and has good workability.

### Means for Solving the Problem

The paint according to embodiments of the present invention comprises a zinc powder, a binder made of an organic resin, calcium sulfate, and a dispersant, wherein a content of the calcium sulfate is 0.046 to 0.186 mol per 100 g of a heating residue of a coating film (from which sulfate added is excluded), a weight ratio of zinc to a dried coating film from which the calcium sulfate is excluded is 70 wt %, a weight ratio of the dispersant to the calcium sulfate is 0.05 to 0.5 wt %, and the dispersant is constituted by at least one of a block copolymer having a basic group with pigment affinity, an oil-soluble non-ionic active agent, and a polyether-modified silicone.

### Effects of Embodiments of the Invention

As described above, embodiments of the present invention can achieve a paint that permits uniform dispersion of calcium sulfate though including a large amount of calcium sulfate, has favorable corrosion protective properties, and has good workability, because a dispersant constituted by at least one of a block copolymer having a basic group with pigment affinity, an oil-soluble non-ionic active agent, and a polyether-modified silicone is used.

### DETAILED DESCRIPTION OF ILLUSTRATIVE EMBODIMENTS

Hereinafter, the paint according to an embodiment of the present invention will be described. The paint according to an embodiment contains a zinc powder and a binder made of an organic resin as a basic configuration, as well known as a zinc-rich paint. The binder can be constituted by epoxy resin.

In embodiments of the present invention, this paint contains calcium sulfate and a dispersant. The content of the calcium sulfate in this paint is 0.046 to 0.186 mol per 100 g of a heating residue of a coating film (from which sulfate added is excluded). The weight ratio of zinc to a dried coating film from which the calcium sulfate is excluded in this paint is 70 wt %. The weight ratio of the dispersant to the calcium sulfate is 0.05 to 0.5 wt %.

The dispersant is constituted by at least one of a block copolymer having a basic group with pigment affinity, an oil-soluble non-ionic active agent, and a polyether-modified silicone. For example, DISPERBYK-2155 manufactured by BYK GmbH, or FLOWLEN D-90 or POLYFLOW KL-401 manufactured by Kyoeisha Chemical Co., Ltd. is suitably used as the dispersant. The dispersant is for uniformly dispersing the calcium sulfate into the paint.

Hereinafter, embodiments of the present invention will be described in more detail with reference to experimental results.

### Experiment

### Sample Preparation

Calcium sulfate dihydrate (hereinafter, referred to as calcium sulfate) and each dispersant were added to a commercially available zinc-rich paint (“SD Zinc 500 Mild” from Kansai Paint Co., Ltd.) to prepare a sample. SD Zinc 500 Mild is a paint having a zinc powder and a binder constituted by epoxy resin as a main composition (zinc-rich paint).

In the experiment, plural types of samples given below were prepared. Calcium sulfate was added such that the weight ratio of the calcium sulfate dihydrate to a heating residue of a coating film is a ratio of 100:8, 100:16, or 100:32. Further, a dispersant was weighed in an amount of 0.05 to 0.5 wt % of the calcium sulfate based on the weight of the calcium sulfate, and added. A steel plate was coated with the resulting paint to prepare a sample. The dispersants used in the experiment are ₇ types, DISPERBYK-145, DISPERBYK-180, and DISPERBYK-2155 manufactured by BYK GmbH, and FLOWLEN D-90, POLYFLOW KL-100, POLYFLOW KL-401, and POLYFLOW KL-403 manufactured by Kyoeisha Chemical Co., Ltd.

Most of commercially available solvent-based zinc-rich paints are a combination of a “mixed liquid of a zinc powder, a resin, and a solvent” and a “curing agent”, and the accurate amount of zinc is unknown. Therefore, the calcium sulfate was added at its weight ratio to a heating residue, which is a parameter described in the paint's instructions. Since SD Zinc 500 Mild used in the experiment is an organic zinc-rich paint that is in accordance with “JIS K 5553 High Build Type Zinc-Rich Paint Type 2”, the amount of metal zinc in a heating residue is at least 70 wt % or more. Usually, the zinc contents of organic zinc-rich paints are on the order of 70 to 90 wt %.

A “post-corrosion power tool-cleaned steel plate” (plate material of 150 mm×70 mm in planar view with a thickness of 3.2 mm) which underwent corrosion with an aqueous sodium chloride solution followed by surface preparation by power tool cleaning (ISO 8501-1 St 3) was used as the steel plate to be coated with each of the paints adjusted at the ratios shown in Tables 1 and 2 below.

For all the paints, the weight was measured such that the amount of application (coating) after drying was 320 g/m², while the steel plate was coated therewith by brush painting. After application to posterior half and drying, the weight was measured again such that the amount of application (coating) was 320 g/m², while the second coating was carried out by brush painting. In short, the total amount of coating was a dry weight of 640 g/m² for all the paints (samples).

After coating with each zinc-rich paint supplemented with calcium sulfate and each dispersant and drying, an artificial scratch reaching the steel product was made in an “x” mark pattern in the lower half region as to all the coated samples using a cutter knife having a small blade to prepare a “damaged part of the coating film”, in order to evaluate a sacrificial protective effect and a protective covering effect on a scratched portion in the coating film.

Each paint with the damaged part of the coating film formed thereon was subjected to a combined cycle test, which repeats salt water spraying, wetting, and drying. The test conditions of the combined cycle test involved carrying out the NTT combined cycle test described in Reference 1 for 2000 hours. As described in Reference 2, when zinc corrodes with sea water, sulfate ions contained in the sea water generate gordaite having high protective properties. However, the aqueous sodium chloride solution used in the technique of Reference 1 contains no sulfate ion. Hence, the “new corrosion test solution (pH 5)” described in Reference 3, not the solution described in Reference 1, was used here as a test solution for the accurate performance evaluation of each paint.

### Experimental Results

The experiment results are shown in Tables 1 and 2. In the column of workability, a sample was indicated by open circle (∘) when the paint was difficult to aggregate with much ease of application, as compared with “Not added”. Corrosion protective properties were evaluated in terms of the degree of progression of corrosion of the base material (steel plate) in the neighborhood of the “damaged part of the coating film” by comparison with a dispersant-free (“Not added”) sample. In the column of corrosion protective properties, a sample was indicated by open circle (∘) when the corrosion protective properties were improved as compared with “Not added”; a sample was indicated by open triangle (Δ) when the corrosion protective properties were rarely changed; and a paint was indicated by x-mark (X) when the corrosion protective properties were rather deteriorated.

TABLE 1

| | Amount of calcium | | Amount of | | | |
|---|---|---|---|---|---|---|
| | sulfate dihydrate added | | dispersant added | | | Corrosion |
| Dispersant | (vs. heating residue | | (vs. calcium | | | protective |
| Trade name | of coating film) | | sulfate dihydrate) | | Workability | property |
| Not added | 8 | wt % | Not added | | Slightly | Good |
| | | | | | poor | |
| | 16 | wt % | Not added | | Poor | Slightly |
| | | | | | | lower than |
| | | | | | | 8 wt % |
| | 32 | wt % | Not added | | Poor | Lower than |
| | | | | | | 16 wt % |
| DISPERBYK- | 8 | wt % | 0.2 | wt % | ∘ | x |
| 145 | 16 | wt % | 0.2 | wt % | ∘ | x |
| | 32 | wt % | 0.2 | wt % | ∘ | x |
| DISPERBYK- | 8 | wt % | 0.2 | wt % | ∘ | x |
| 180 | 16 | wt % | 0.2 | wt % | ∘ | x |
| | 32 | wt % | 0.2 | wt % | ∘ | x |
| DISPERBYK- | 8 | wt % | 0.05 | wt % | ∘ | ∘ |
| 2155 | 8 | wt % | 0.2 | wt % | ∘ | ∘ |
| | 8 | wt % | 0.5 | wt % | ∘ | Δ |
| | 16 | wt % | 0.05 | wt % | ∘ | Δ |
| | 16 | wt % | 0.2 | wt % | ∘ | Δ |
| | 16 | wt % | 0.5 | wt % | ∘ | Δ |
| | 32 | wt % | 0.05 | wt % | ∘ | Δ |
| | 32 | wt % | 0.2 | wt % | ∘ | Δ |
| | 32 | wt % | 0.5 | wt % | ∘ | Δ |

TABLE 2

| | Amount of calcium | | Amount of | | | |
|---|---|---|---|---|---|---|
| | sulfate dihydrate added | | dispersant added | | | Corrosion |
| Dispersant | (vs. heating residue | | (vs. calcium | | | protective |
| Trade name | of coating film) | | sulfate dihydrate) | | Workability | property |
| FLOWLEN | 8 | wt % | 0.05 | wt % | ∘ | ∘ |
| D-90 | 8 | wt % | 0.2 | wt % | ∘ | ∘ |
| | 8 | wt % | 0.5 | wt % | ∘ | Δ |
| | 16 | wt % | 0.05 | wt % | ∘ | Δ |
| | 16 | wt % | 0.2 | wt % | ∘ | Δ |
| | 16 | wt % | 0.5 | wt % | ∘ | Δ |
| | 32 | wt % | 0.05 | wt % | ∘ | Δ |
| | 32 | wt % | 0.2 | wt % | ∘ | Δ |
| | 32 | wt % | 0.5 | wt % | ∘ | Δ |
| POLYFLOW | 8 | wt % | 0.2 | wt % | ∘ | x |
| KL-100 | 16 | wt % | 0.2 | wt % | ∘ | x |
| | 32 | wt % | 0.2 | wt % | ∘ | x |
| POLYFLOW | 8 | wt % | 0.05 | wt % | ∘ | ∘ |
| KL-401 | 8 | wt % | 0.2 | wt % | ∘ | ∘ |
| | 8 | wt % | 0.5 | wt % | ∘ | Δ |
| | 16 | wt % | 0.05 | wt % | ∘ | Δ |
| | 16 | wt % | 0.2 | wt % | ∘ | Δ |
| | 16 | wt % | 0.5 | wt % | ∘ | Δ |
| | 32 | wt % | 0.05 | wt % | ∘ | Δ |
| | 32 | wt % | 0.2 | wt % | ∘ | Δ |
| | 32 | wt % | 0.5 | wt % | ∘ | Δ |
| POLYFLOW | 8 | wt % | 0.2 | wt % | ∘ | x |
| KL-403 | 16 | wt % | 0.2 | wt % | ∘ | x |
| | 32 | wt % | 0.2 | wt % | ∘ | x |

When the coated samples were compared with dispersant-free samples A, workability was improved in almost all the paints; however, corrosion protective properties were reduced in many samples compared with the dispersant-free samples. Although corrosion protective properties were rather deteriorated in many samples, relatively favorable results were obtained in the coated samples supplemented with DISPERBYK-2155, FLOWLEN D-90, or POLYFLOW KL-401, which exhibited improved corrosion protective properties and workability. Paints supplemented with 0.05 to 0.5 wt % of these dispersants can improve workability without causing reduction in corrosion protective properties. It was also confirmed that corrosion protective properties were slightly improved in the paints supplemented with 8 wt % of the calcium sulfate with respect to a heating residue of a coating film and 0.05 to 0.2 wt % of the dispersant with respect to the calcium sulfate.

The coatings prepared as samples (coated samples) had a thinner coating film at an edge portion than at other portions. Hence, when calcium sulfate is included in the coating film of the sample portion, small portions of the calcium sulfate eventually elutes from the coating film so that portions having the calcium sulfate become voids. Hence, if the edge portion of a coated sample having a thin coating film has a portion where calcium sulfate is unevenly distributed, red rust occurs easily. Thus, even the same amount of calcium sulfate added as that in such a coated sample presumably produced more favorable results by uniformly dispersing the calcium sulfate by the addition of the dispersant.

Although the effectiveness of a dispersant for uniformly dispersing calcium sulfate can be easily surmised, a specific kind (type) of dispersant effective for the dispersion of calcium sulfate was not revealed and could not be easily surmised. As a result of testing many dispersants reportedly effective for inorganic salts in this experiment, dispersants highly effective for the dispersion of sulfate in zinc-rich paints have been found for the first time.

In the experiment, calcium sulfate dihydrate was added in an amount of 8 to 32 wt % with respect to the weight of a heating residue of a coating film. In terms of molar quantity, this corresponds to 0.046 to 0.186 mol of calcium sulfate added per 100 g in weight of a heating residue of a coating film (from which sulfate added is excluded). Hence, in the case of adding sulfate other than calcium sulfate to a solvent-free zinc-rich paint, the sulfate is added in an amount of 0.046 to 0.186 mol per 100 g in weight of a heating residue of a coating film.

The coated samples supplemented with calcium sulfate (dihydrate) in an amount of 8 to 16 wt % of the weight of a heating residue of a coating film produced particularly favorable results. Thus, it is particularly desirable that calcium sulfate should be added in the range of 0.046 to 0.093 mol per 100 g in weight of a heating residue of a coating film from which the calcium sulfate is excluded.

In the experiment, favorable results were obtained by the addition of DISPERBYK-2155 manufactured by BYK GmbH, and FLOWLEN D-90 and POLYFLOW KL-401 manufactured by Kyoeisha Chemical Co., Ltd. The addition of each of these additives in an amount of 0.05 to 0.5 wt % of the weight of calcium sulfate produced favorable results. It is particularly desirable that the dispersant should be added in the range of 0.05 to 0.2 wt % of the weight of calcium sulfate to a coated sample supplemented with 8 to 16 wt % of calcium sulfate based on a heating residue of a coating film. DISPERBYK-2155 manufactured by BYK GmbH is a block copolymer dispersant having a basic group with pigment affinity, and FLOWLEN D-90 and POLYFLOW KL-401 manufactured by Kyoeisha Chemical Co., Ltd. are dispersants of an oil-soluble non-ionic active agent and a polyether-modified silicone, respectively. Other commercial products are also suitably used as long as the dispersants are of these families.

The experiment mentioned above was conducted using SD Zinc 500 Mild from Kansai Paint Co., Ltd. as a zinc-rich paint. Any organic zinc-rich paint having a high concentration of a zinc powder and containing an organic resin produces similar effects, irrespective of the type of a binder and the types of contained components other than a zinc powder and calcium sulfate.

A powder of zinc alloy (zinc-based alloy) of zinc supplemented with a small amount of aluminum or magnesium may be used as a zinc powder for zinc-rich paints for the purpose of improving corrosion resistance. Any zinc-rich paint containing such a powder prepared using alloy composed mainly of zinc releases zinc ions by the corrosion of the zinc alloy, as in usual zinc-rich paints, and therefore produces similar effects through the use of embodiments of the present invention.

As described above, embodiments of the present invention can achieve a paint that permits uniform dispersion of calcium sulfate though including a large amount of calcium sulfate, has favorable corrosion protective properties, and has good workability, because a dispersant constituted by at least one of a block copolymer having a basic group with pigment affinity, an oil-soluble non-ionic active agent, and a polyether-modified silicone is used.

The present invention is not limited by the embodiments described above. It is obvious that various changes or modifications and combinations can be made by those ordinarily skilled in the art without departing from the technical brief of the present invention.

### REFERENCES

Reference 1—Takashi Miwa, Yukitoshi Takeshita, Azusa Ishii, “Technical report—Comparison of corrosion behaviors by various accelerated corrosion tests or field exposure tests using coated steel plates”, Rust Prevention & Control Japan, 61, 12, p. 449-455, 2017

Reference 2—N. S. Azmat et al., “Corrosion of Zn under acidified marine droplets”, Corrosion Science, vol. 53, pp. 1604-1615, 2011

Reference 3—Takashi Miwa, Azusa Ishii, Hiroshi Koizumi, “Study on accelerated corrosion test solutions more accurately reproducing atmospheric corrosion of zinc in salt-laden environments”, 2018 Proceedings of JSCE materials and environments, B-308, p. 193-196, 2018.

1.-2. (canceled)

3. A paint comprising:
a zinc powder;
a binder made of an organic resin, calcium sulfate, and a dispersant;
wherein a content of the calcium sulfate is 0.046 to 0.186 mol per 100 g of a heating residue of a coating film, wherein sulfate is excluded from the coating film;
wherein a weight ratio of zinc to a dried coating film is 70 wt %, wherein calcium sulfate is excluded from the dried coating film;
wherein a weight ratio of the dispersant to the calcium sulfate is 0.05 to 0.5 wt %; and
wherein the dispersant is constituted by a block copolymer having a basic group with pigment affinity, an oil-soluble non-ionic active agent, or a polyether-modified silicone.

4. The paint according to claim 3, wherein the binder is constituted by epoxy resin.

5. A paint comprising:
a zinc powder;
a binder made of an organic resin, calcium sulfate, and a dispersant;
wherein a content of the calcium sulfate is 0.046 to 0.186 mol per 100 g of a heating residue of a coating film, wherein sulfate is excluded from the coating film;
wherein a weight ratio of zinc to a dried coating film is 70 wt %, wherein calcium sulfate is excluded from the dried coating film; and
wherein a weight ratio of the dispersant to the calcium sulfate is 0.05 to 0.5 wt %.

6. The paint according to claim 5, wherein the dispersant is constituted by a block copolymer having a basic group with pigment affinity.

7. The paint according to claim 5, wherein the dispersant is constituted by an oil-soluble non-ionic active agent.

8. The paint according to claim 5, wherein the dispersant is constituted by a polyether-modified silicone.

9. The paint according to claim 5, wherein the binder is constituted by epoxy resin.

10. A method comprising:
forming a paint comprising a zinc powder and a binder made of an organic resin, calcium sulfate, and a dispersant;
wherein a content of the calcium sulfate is 0.046 to 0.186 mol per 100 g of a heating residue of a coating film, wherein sulfate is excluded from the coating film;
wherein a weight ratio of zinc to a dried coating film is 70 wt %, wherein calcium sulfate is excluded from the dried coating film;
wherein a weight ratio of the dispersant to the calcium sulfate is 0.05 to 0.5 wt %; and
wherein the dispersant is constituted by a block copolymer having a basic group with pigment affinity, an oil-soluble non-ionic active agent, or a polyether-modified silicone.

11. The method according to claim 10, wherein the binder is constituted by epoxy resin.
